(19) United States
(12) Patent Application Publication
(10) Pub. No.: US 2022/0335880 A1
(43) Pub. Date: Oct. 20, 2022

(54) Electroluminescence Display, Pixel Compensating Circuit and Voltage Compensating Method Based on Pixel Compensating Circuit

(71) Applicant: CHONGQING KONKA PHOTOELECTRIC TECHNOLOGY RESEARCH INSTITUTE CO., LTD., Chongqing (CN)

(72) Inventor: Shisong ZHENG, Chongqing (CN)

(21) Appl. No.: 17/057,705

(22) PCT Filed: Dec. 19, 2019
(86) PCT No.: PCT/CN2019/126527

§ 371 Date: Nov. 23, 2020

(51) Int. Cl. G09G 3/32

(52) U.S. Cl. CPC G09G 3/32; G09G 2300/043; G09G 2300/0876; G09G 2310/08

(57) ABSTRACT

An electroluminescence display, a pixel compensating circuit and a voltage compensating method based on the pixel compensating circuit are provided. The pixel compensating circuit includes: a first switch module configured to provide a second reference voltage for a first end of the compensation storage capacitor in a first time period, and provide a compensation voltage for the first end of the compensation storage capacitor in a second time period; a second switch module configured to provide a first reference voltage for a second end of the compensation storage capacitor in the first time period and the second time period; a third switch module configured to provide the second reference voltage for the second end of the compensation storage capacitor in a third time period; and a fourth switch module configured to control an electroluminescence device to emit light in the third time period.

### TECHNICAL FIELD

The present disclosure relates to the field of display technologies, and in particular to an electroluminescence display, a pixel compensating circuit and a voltage compensating method based on the pixel compensating circuit.

### BACKGROUND

Electroluminescence (EL) devices include Organic Light-Emitting Diodes (OLED), Light Emitting Diodes (LED) and the like. In recent years, EL devices are widely used for manufacturing a display product. Compared with traditional displays (CRT, LCD. etc.), the display products applying the EL devices show better optical characteristics, lower power consumption performance, and better product morphological plasticity. However, because of the property that the EL device is driven by a current, when being used for manufacturing a display, the EL device needs to be driven by adopting a typical active matrix (AM) or passive matrix (PM) driving method. Due to a large electrical load generated when the current passes through a circuit and the EL device, a brightness uniformity problem caused by an IR-drop effect is inevitably generated. The problem causes a drop of a voltage value to the extent that the voltage value is deviated from a supply voltage value of an original voltage source. thereby directly reducing a driving cross voltage of the EL device and a current flowing through the EL device, finally reducing the brightness and the brightness uniformity of a panel, and greatly impacting the picture quality of the display.

Specifically, as shown in FIG. 1a, FIG. 1b and FIG. 1c, based on a typical display driving method and circuit design, a common power supply is adopted, which means that except for pixel points on an edge of the panel, pixels in a display area are powered by direct wiring of the circuit. When the EL device is operated for luminescence, the large electrical load provided causes that the pixel points in the display area may generate different voltage drops, which directly results in the reduction of the brightness and deterioration of the brightness uniformity. Namely, sub-pixels CKT1 and CKT2 in different positions of the display panel are connected in a backplane circuit through multiple resistances and electrical connection lines, when an input voltage VDD is input from one end, due to the electrical load on a circuit series path, the sub-pixel closer to the VDD has larger input voltage and input current, while the sub-pixel farther away from the VDD has smaller input voltage and input current. When the voltage drops, due to the electrical load on the circuit series path, VDD will be larger than VDDCKT.1, and VDDCKT.1 will be larger than VDDCKT.2, i.e., VDD>VDDCKT.1>VDDCKT.2. When the current drops, due to the voltage drop of the VDD on the path, the cross voltage of the corresponding EL device will also drop, which makes ICKT.1>ICKT.2. When the brightness is reduced, because the EL device gives out light by the driving of a current, a direct brightness variety will be caused by the drop of the current, that is, BriCKT.1>BriCKT.2, and different sub-pixels on the same display panel will have different luminescence brightness, so a problem of luminescence brightness non-uniformity is caused.

Therefore, the related art needs to be improved and enhanced.

### SUMMARY

In view of disadvantages of the above related art, the embodiments of the present disclosure provide an electroluminescence display, a pixel compensating circuit and a voltage compensating method based on the pixel compensating circuit, so that brightness of an electroluminescence device does not vary with the change of the distance between the electroluminescence device and the voltage input end, and a problem of brightness non-uniformity of the display is effectively addressed.

In order to achieve the above purpose, the embodiments of the present disclosure adopt the following technical schemes.

A pixel compensating circuit includes a compensation storage capacitor, a first switch module, a second switch module, a third switch module and a fourth switch module. The first switch module is configured to provide a second reference voltage for a first end of the compensation storage capacitor in a first time period according to an input voltage, a first control signal and a second control signal, and provide a compensation voltage for the first end of the compensation storage capacitor in a second time period according to the input voltage and the second control signal. The second switch module is configured to provide a first reference voltage for a second end of the compensation storage capacitor in the first time period and the second time period according to the second control signal. The third switch module is configured to provide the second reference voltage for the second end of the compensation storage capacitor in a third time period according to a third control signal. The fourth switch module is configured to control an electroluminescence device to emit light in the third time period according to a fourth control signal.

In the pixel compensating circuit, the first switch module includes a first transistor, a second transistor, a third transistor and a fourth transistor. A first end of the first transistor is connected to electrical power, a control end of the first transistor and a first end of the fourth transistor are connected with the first end of the compensation storage capacitor, a first end of the third transistor and a second end of the first transistor are connected with the third switch module, a second end of the third transistor and a second end of the fourth transistor are connected with a first end of the second transistor, a second end of the second transistor is connected with an input end of the second reference voltage, a control end of the second transistor is connected with a first scanning line, and a control end of the third transistor and a control end of the fourth transistor are connected with a second scanning line.

In the pixel compensating circuit, the second switch module includes a fifth transistor. A control end of the fifth transistor is connected with the second scanning line, a first end of the fifth transistor is connected with an input end of the first reference voltage, and a second end of the fifth transistor is connected with the second end of the compensation storage capacitor.

In the pixel compensating circuit, the third switch module includes a sixth transistor and a seventh transistor. A control end of the sixth transistor and a control end of the seventh transistor are connected with a third scanning line, a first end of the sixth transistor is connected with the second end of the compensation storage capacitor, a second end of the sixth transistor is connected with the input end of the second reference voltage, a first end of the seventh transistor is connected with the second end of the first transistor, and a second end of the seventh transistor is connected with the fourth switch module.

In the pixel compensating circuit, the fourth switch module includes an eighth transistor. A control end of the eighth transistor is connected with a fourth scanning line, a first end of the eighth transistor is connected with the second end of the seventh transistor, and a second end of the eighth transistor is connected with a positive pole of the electroluminescence device.

In the pixel compensating circuit, the fourth switch module includes an eighth transistor. A control end of the eighth transistor is connected with a fourth scanning line, a first end of the eighth transistor is connected with the second end of the seventh transistor, and a second end of the eighth transistor is connected with a negative pole of the electroluminescence device.

In the pixel compensating circuit, the first transistor, the second transistor, the third transistor and the fourth transistor are P-channel transistors; or the first transistor, the second transistor, the third transistor and the fourth transistor are N-channel transistors.

In the pixel compensating circuit, the eighth transistor is a P-channel transistor.

A voltage compensating method based on the pixel compensating circuit as mentioned above includes the following operations.

In the first time period, the first switch module provides the second reference voltage for the first end of the compensation storage capacitor according to the input voltage, the first control signal and the second control signal; and the second switch module provides the first reference voltage for the second end of the compensation storage capacitor according to the second control signal.

In the second time period, the first switch module provides the compensation voltage for the first end of the compensation storage capacitor according to the input voltage and the second control signal; and the second switch module provides the first reference voltage for the second end of the compensation storage capacitor according to the second control signal.

In the third time period, the third switch module and the fourth switch module control the electroluminescence device to emit light according to the third control signal and the fourth control signal, and provide the second reference voltage for the second end of the compensation storage capacitor.

An electroluminescence display includes a pixel array, wherein the pixel array includes at least one pixel circuit, the pixel circuit includes three sub-pixel circuits, and each of the sub-pixel circuits includes an electroluminescence device and the pixel compensating circuit as mentioned above.

Compared with a related art, the embodiments of the present disclosure provide an electroluminescence display, a pixel compensating circuit and a voltage compensating method based on the pixel compensating circuit. The pixel compensating circuit includes a compensation storage capacitor, a first switch module, a second switch module, a third switch module and a fourth switch module. The first switch module is configured to provide a second reference voltage for a first end of the compensation storage capacitor in a first time period according to an input voltage, a first control signal and a second control signal, and provide a compensation voltage for the first end of the compensation storage capacitor in a second time period according to the input voltage and the second control signal. The second switch module is configured to provide a first reference voltage for a second end of the compensation storage capacitor in the first time period and the second time period according to the second control signal. The third switch module is configured to provide the second reference voltage for the second end of the compensation storage capacitor in a third time period according to a third control signal. The fourth switch module is configured to control an electroluminescence device to emit light in the third time period according to a fourth control signal. The scheme in the embodiments of the present disclosure is capable of, through sequential control on each switch module, achieving a function of compensating a voltage or a current, so that the brightness of the electroluminescence device does not vary with the change of the distance between the electroluminescence device and the voltage input end, thereby effectively addressing a problem of brightness non-uniformity of the display, and guaranteeing that each sub-pixel in the electroluminescence display has the same luminescence brightness.

### BRIEF DESCRIPTION OF THE DRAWINGS

FIG. 1a, FIG. 1b and FIG. 1c are circuit schematic diagrams of sub-pixel circuits in a related art;

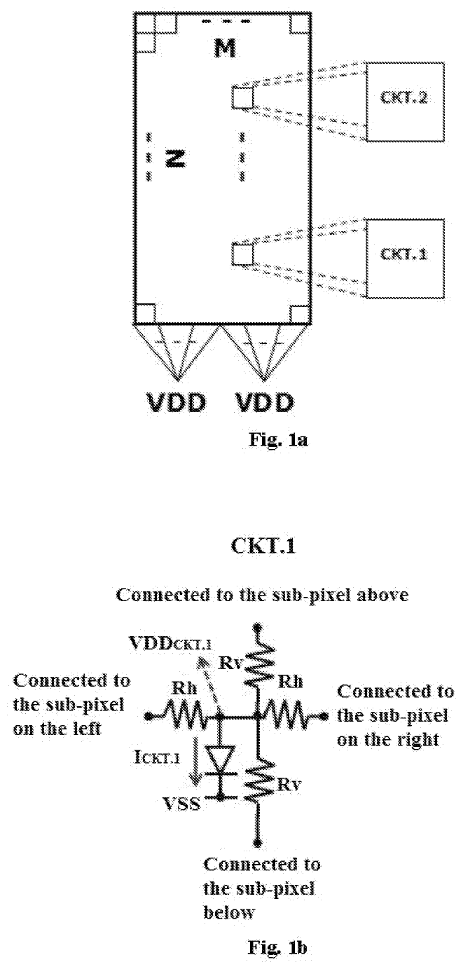

FIG. 2 is a circuit schematic diagram of a pixel compensating circuit according to a first embodiment provided by the present disclosure;

FIG. 3 is a working schematic diagram of the pixel compensating circuit according to the first embodiment provided by the present disclosure in a first time period;

FIG. 4 is a sequence diagram of each control signal of the pixel compensating circuit according to the first embodiment provided by the present disclosure in the first time period;

FIG. 5 is a working schematic diagram of the pixel compensating circuit according to the first embodiment provided by the present disclosure in a second time period;

FIG. 6 is a sequence diagram of each control signal of the pixel compensating circuit according to the first embodiment provided by the present disclosure in the second time period;

FIG. 7 is a working schematic diagram of the pixel compensating circuit according to the first embodiment provided by the present disclosure in a third time period;

FIG. 8 is a sequence diagram of each control signal of the pixel compensating circuit according to the first embodiment provided by the present disclosure in the third time period;

FIG. 9 is a circuit schematic diagram of the pixel compensating circuit according to a second embodiment provided by the present disclosure;

FIG. 10 is a sequence diagram of each control signal of the pixel compensating circuit according to the second embodiment provided by the present disclosure; and

FIG. 11 is a flow diagram of a voltage compensating method based on the pixel compensating circuit according to the embodiments provided by the present disclosure.

### DETAILED DESCRIPTION OF THE EMBODIMENTS

The embodiments of the present disclosure provide an electroluminescence display, a pixel compensating circuit and a voltage compensating method based on the pixel compensating circuit, so that brightness of an electroluminescence device does not vary with the change of the distance between the electroluminescence device and the voltage input end, and a problem of brightness non-uniformity of the display is effectively addressed.

In order to make purposes, technical schemes and effects of the embodiments of the present disclosure more clear and specific, the scheme of the present disclosure is further described in detail below with reference to drawings and embodiments. It should be understood that the exemplary embodiments described here are only used to explain the present disclosure, and are not used to limit the present disclosure.

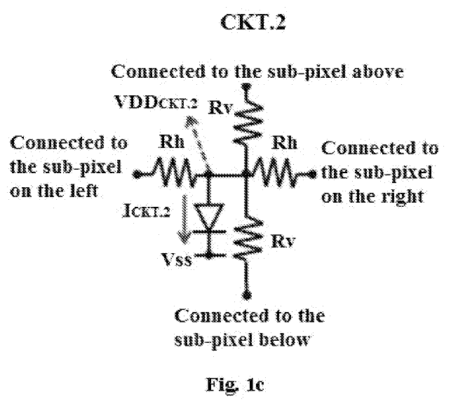

As shown in FIG. 2, the pixel compensating circuit provided by an embodiment of the present disclosure is connected with an electroluminescence device (EL), and includes a compensation storage capacitor C1, a first switch module 100, a second switch module 200, a third switch module 300 and a fourth switch module 400. The first switch module 100 is connected with a voltage input end, a first scanning line, a second scanning line and a first end of the compensation storage capacitor C1, is also connected with the third switch module 300. The second switch module 200 is connected with an input end of the first reference voltage, the first scanning line and a second end of the compensation storage capacitor C1. The third switch module 300 is connected with the fourth switch module 400 and a third scanning line. The fourth switch module 400 is connected with a fourth scanning line and the electroluminescence device (EL). In the embodiment, the first scanning line, the second scanning line and the third scanning line provide row control signals for the pixel compensating circuit, which is a first control signal S1[n], a second control signal S2[n] and a third control signal EM[n] respectively, wherein the first control signal S1 [n], the second control signal S2[n] and the third control signal EM[n] are used for a purpose of functional operations of the pixel compensating circuit. In the embodiment, the fourth scanning line provides a column control signal for the pixel compensating circuit, namely a fourth control signal SEL[n], wherein the fourth control signal SEL[n] is a PWM function signal, and is used to control luminescence time of the electroluminescence device (EL).

Specifically, the first switch module 100 is configured to provide a second reference voltage for the first end of the compensation storage capacitor C1 in a first time period according to the input voltage, the first control signal S1[n] and the second control signal S2[n], and provide a compensation voltage for the first end of the compensation storage capacitor C1 in a second time period according to the input voltage and the second control signal S2[n]. The second switch module 200 is configured to provide a first reference voltage for a second end of the compensation storage capacitor C1 in the first time period and the second time period according to the second control signal S2[n]. The third switch module 300 is configured to provide the second reference voltage for the second end of the compensation storage capacitor C1 in a third time period according to the third control signal EM[n]. The fourth switch module 400 is configured to control the electroluminescence device (EL) to emit light in the third time period according to the fourth control signal. Through sequential control on each switch module, a function of compensating a voltage or a current is achieved, so that the brightness of the electroluminescence device (EL) does not vary with the change of the distance between the EL and the voltage input end, thereby a problem of brightness non-uniformity of the display is effectively addressed, and it can be guaranteed that each sub-pixel in the electroluminescence display has the same luminescence brightness.

The pixel compensating circuit provided by the embodiment of the present disclosure has three phases in a working process, which is an initialization phase (first time period), a voltage compensation phase (second time period) and a luminescence display phase (third time period) respectively. Before the initialization phase, after the control in a previous time sequence, there may be a capacitance difference of the previous time sequence left in the compensation storage capacitor C1. The residual signal of the previous time sequence may be eliminated through the initialization phase to avoid the effect of the residual signal on a current operation. In the initialization phase, the first switch module 100 and the second switch module 200 are controlled, through the first control signal S1[n] and the second control signal S2[n], to operate, and at this time the voltage input end provides an input voltage and the input end of the second reference voltage provides the second reference voltage to charge the compensation storage capacitor C1 through the second switch module 200, so that the voltage at the first end of the compensation storage capacitor C1 is equal to the second reference voltage, namely Va=VREF2; at the same time, the second control signal S2[n] controls to enable the first reference voltage provided at the input end of the first reference voltage charges the compensation storage capacitor C1 through the second switch module 200, so that the voltage at the second end of the compensation storage capacitor C1 is equal to the first reference voltage, namely Vb=VREF1. In this way, two ends of the compensation storage capacitor C1 reach the first reference voltage and the second reference voltage respectively, so as to eliminate the effect of the residual voltage of the previous time sequence.

In the voltage compensation phase, only the second control signal S2[n] participates in the control, at this time the first reference voltage provided at the input end of the first reference voltage changes the compensation storage capacitor C1 through the second switch module 200, so that the voltage at the second end of the compensation storage capacitor C1 is still equal to the first reference voltage, namely Vb=VREF1. Because the second control signal S2[n] does not participate in the control at this moment, the first switch module 100 only changes the compensation storage capacitor C1 through the input voltage provided by the voltage input end, and the charging is stopped after a compensation voltage is provided for the compensation storage capacitor C1, at this moment the voltage Va at the first end of the compensation storage capacitor C1 is Va=VDD-compensation voltage, herein, VDD is the input voltage.

In the luminescence display phase, the second control signal S2[n] and the first control signal S1[n] do not participate in the control, instead the third control signal EM[n] and the fourth control signal SEL[n] participate in the control. The corresponding second reference voltage provided at the input end of the second reference voltage changes the compensation storage capacitor C1 through the third switch module 300, so that the voltage at the second end of the compensation storage capacitor C1 changes from the first reference voltage to the second reference voltage, namely Vb=VREF2 at this moment. Due to the characteristics of the capacitance, when the voltage at one end of the compensation storage capacitor C1 changes, in order to maintain a constant voltage difference, the voltage at the other end of the compensation storage capacitor C1 changes accordingly, the voltage Va at the first end of the compensation storage capacitor C1 is Va=VDD-compensation voltage+(VREF2−VREF1) (1). At the same time, the fourth switch module 400, under the control of the fourth control signal SEL[n], enables the input voltage at the voltage input end to supply power to the electroluminescence device (EL), so that the electroluminescence device (EL) emits light, and the current corresponding to the electroluminescence device (EL) is:

IEL=k*(VDD−Va-compensation voltage)² (2).

The voltage at the first end of the compensation storage capacitor C1 after the voltage compensation, namely the formula (1), is substituted into the formula (2), then the following equation can be obtained:

IEL=k*(VREF1−VREF2)² (3).

It may be observed that a parameter factor of the VDD is not contained in the formula (3), thus regardless of a distance between the sub-pixel and the voltage input end, the voltage or the current flowing through the sub-pixel will not be affected by the input voltage VDD, so the brightness of the electroluminescence device (EL) will not be affected, thereby the IR-drop problem is avoided, the problem of the brightness non-uniformity of the display is effectively addressed, and each sub-pixel in the electroluminescence display has the same luminescence brightness. In the embodiment, k is a semiconductor parameter, which is a fixed constant.

During specific implementation, in the first embodiment, as shown in FIG. 2, the first switch module 100 includes a first transistor T1, a second transistor T2, a third transistor T3 and a fourth transistor T4. A first end of the first transistor T1 is connected to electrical power, a control end of the first transistor T1 and a first end of the fourth transistor T4 are connected with the first end of the compensation storage capacitor C1, a first end of the third transistor T3 and a second end of the first transistor T1 are connected with the third switch module 300, a second end of the third transistor T3 and a second end of the fourth transistor T4 are connected with a first end of the second transistor T2, a second end of the second transistor T2 is connected with an input end of the second reference voltage, a control end of the second transistor T2 is connected with the first scanning line, and a control end of the third transistor T3 and a control end of the fourth transistor T4 are connected with the second scanning line. In the embodiment, the first transistor T1, the second transistor T2, the third transistor T3 and the fourth transistor T4 are P-channel transistors; or the first transistor T1, the second transistor T2, the third transistor T3 and the fourth transistor T4 are N-channel transistors. In the embodiment, each transistor may be a TFT transistor or a MOS tube. For the sake of exemplary illustration, each transistor in the present embodiment is the P-channel TFT transistor, turn-on or turn-off of the second transistor T2 is controlled by the first control signal S1[n], and turn-on or turn-off of the third transistor T3 and the fourth transistor T4 is controlled by the second control signal S2[n], thereby a charging path of the compensation storage capacitor C1 can be controlled.

Further, the second switch module 200 includes a fifth transistor T5. A control end of the fifth transistor T5 is connected with the second scanning line, a first end of the fifth transistor T5 is connected with the input end of the first reference voltage, and a second end of the fifth transistor T5 is connected with the second end of the compensation storage capacitor C1. The second control signal S2[n] controls, through controlling turn-on or turn-off of the fifth transistor T5, whether the first reference voltage provided at the input end of the first reference voltage charges the compensation storage capacitor C1, so that the compensation voltage can be provided for the compensation storage capacitor C1. In the embodiment, the fifth transistor T5 is the P-channel TFT transistor.

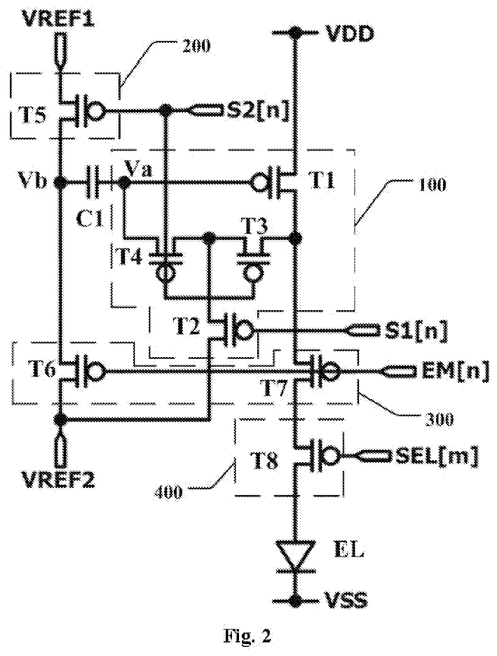

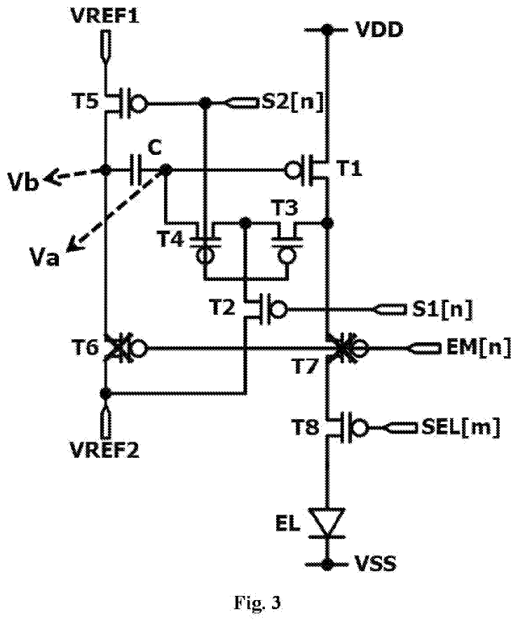

In the initialization phase, as shown in FIG. 3 and FIG. 4, at a time point T1, the second control signal S2[n] is pulled down to a negative edge, the first control signal S1[n] is in a low logic level, the third control signal EM[n] is in a high logic level. At this moment, the first control signal S1[n] controls the second transistor T2 to be turned on, the second control signal S2[n] controls the third transistor T3, the fourth transistor T4 and the fifth transistor T5 to be turned on and enter a working state, and the third control signal EM[n] controls the sixth transistor T6 and the seventh transistor T7 to be turned off, the first reference voltage provided at the input end of the first reference voltage charges the compensation storage capacitor C1 through the fifth transistor T5, so that the voltage at the second end of the compensation storage capacitor C1 is equal to the first reference voltage, namely Vb=VREF1. The second reference voltage input by the input end of the second reference voltage charges the compensation storage capacitor C1 through the second transistor T2 and the fourth transistor T4, at the same time, the input voltage of the voltage input end charges the compensation storage capacitor C1 through the first transistor T1, the third transistor T3 and the fourth transistor T4, so that the voltage at the first end of the compensation storage capacitor C1 is equal to the first reference voltage, namely Va=VREF2, and two ends of the compensation storage capacitor C1 reach the first reference voltage and the second reference voltage respectively, so as to eliminate the effect of the residual voltage of the previous time sequence.

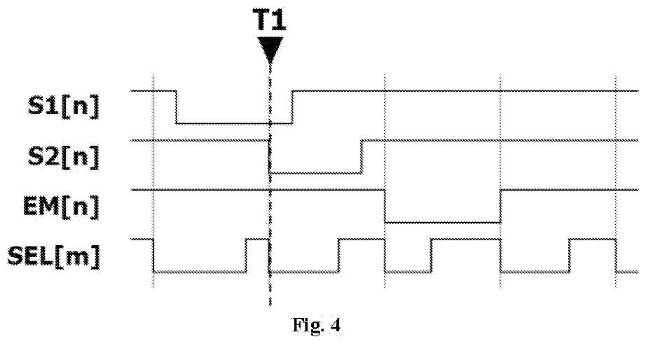

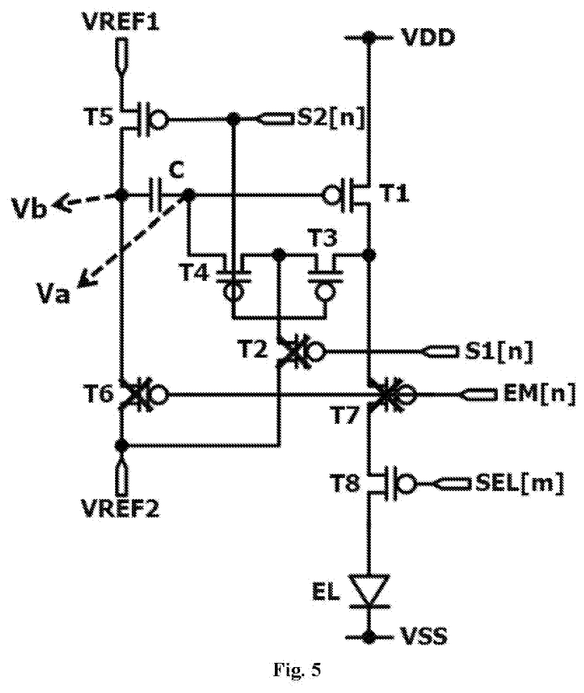

In the voltage compensation phase, as shown in FIG. 5 and FIG. 6, at a time point T2, the first reference voltage is pulled up to the high logic level, the second control signal S2[n] is still in the low logic level, and the third control signal EM[n] is still in the high logic level. In this phase, the first control signal S1[n] controls the second transistor T2 to be turned off, the third control signal EM[n] controls the sixth transistor T6 and the seventh transistor T7 to be turned off, and the second control signal S2[n] controls the fifth transistor T5 to be a turn-on state. At this moment the input voltage of the voltage input end charges the compensation storage capacitor C1 through the first transistor T1, the third transistor T3 and the fourth transistor T4, and the charging is stopped until a gate-source voltage Vgs of the first transistor T1 is |Vth|, namely, when the gate-source voltage Vgs of the first transistor T1 reaches the threshold voltage Vth of the first transistor T1, the input voltage stops charging the compensation storage capacitor C1, at this moment the voltage Va at the first end of the compensation storage capacitor C1 is Va=VDD−|Vth|. Due to the fifth transistor T5 is turned on, the voltage Vb at the second end of the compensation storage capacitor C1 does not change, and is still Vb=VREF1, herein, |Vth| is a voltage value of the compensation voltage provided for the compensation storage capacitor C1 by the pixel compensating circuit, so that the brightness of the subsequent electroluminescence device (EL) does not change with the change of a distance between the EL and the input voltage of the power input end.

Further, as shown in FIG. 2, the third switch module 300 includes a sixth transistor T6 and a seventh transistor T7, a control end of the sixth transistor T6 and a control end of the seventh transistor T7 are connected with a third scanning line, a first end of the sixth transistor T6 is connected with the second end of the compensation storage capacitor C1, a second end of the sixth transistor T6 is connected with an input end of the second reference voltage, a first end of the seventh transistor T7 is connected with a second end of the first transistor T1, and a second end of the seventh transistor T7 is connected with the fourth switch module. Since the third switch module 300 is controlled, by the third control signal EM[n], to be turned on, it can be guaranteed that the electroluminescence device (EL) is connected to electrical power, thereby the electroluminescence device (EL) is driven to emit light. In the embodiment, the sixth transistor T6 and the seventh transistor T7 are P-channel TFT transistors.

Further, the fourth switch module 400 includes an eighth transistor T8, a control end of the eighth transistor T8 is connected with a fourth scanning line, a first end of the eighth transistor T8 is connected with a second end of the seventh transistor T7, and a second end of the eighth transistor T8 is connected with a positive pole of the electroluminescence device (EL). The fourth control signal SEL[n] is a PWM function signal, and the turn-on or turn-off state of the eighth transistor T8 is controlled by the fourth control signal SEL[n], thereby the luminescence time of the electroluminescence device (EL) is controlled. In the present embodiment, the eighth transistor T8 is a P-channel TFT transistor.

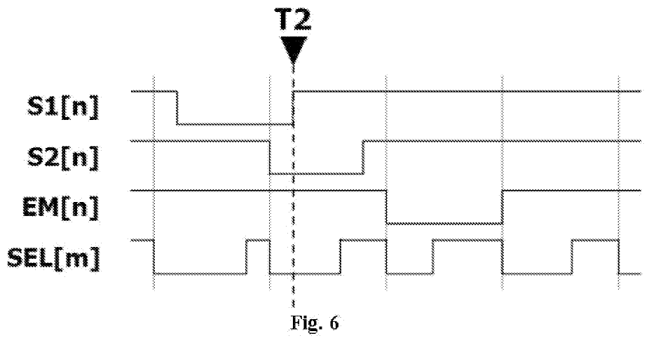

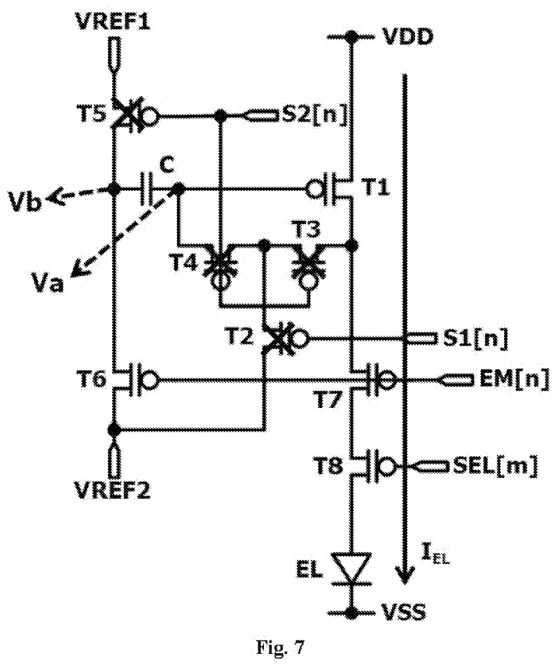

In the luminescence display phase, as shown in FIG. 7 and FIG. 8, at a time point T3, the first control signal S1[n] continues to be in the high logic level, the second control signal S2[n] changes to the high logic level, the third control signal EM[n] is pulled down to the low logic level, and the fourth control signal SEL[n] is pulled down to the low logic level. At this moment, the first control signal S1[n] still controls the second transistor T2 to be turned off, the second control signal S2[n] controls the third transistor T3, the fourth transistor T4 and the fifth transistor T5 to be turned off, the third control signal EM[n] controls the sixth transistor T6 and the seventh transistor T7 to be turned on, and the fourth control signal SEL[n] controls the eighth transistor T8 to be turned on. The input voltage of the power input end supplies power to the electroluminescence device (EL) through the seventh transistor T7 and the eighth transistor T8, so that the electroluminescence device (EL) emits light. The second reference voltage of the input end of the second reference voltage charges the second end of the compensation storage capacitor C1 through the sixth transistor T6, so that the voltage Vb at the second end of the compensation storage capacitor C1 changes to the second reference voltage, namely Vb=VREF2. Due to the characteristics of the capacitance, when the voltage at one end of the capacitance changes, in order to maintain a constant voltage difference, the voltage at the other end of the capacitance changes accordingly, the voltage Va at the other end of the capacitance C is:

Va=VDD−|Vth|+(VREF2−VREF1) (1).

At this moment, an equivalent formula of the current is:

IEL=k*(VDD−Va−|Vth|)² (2).

After the formula (1) is substituted into the formula (2), the following equation may be obtained:

IEL=k*(VREF1−VREF2)² (3).

It may be observed that a parameter factor of the VDD is not contained in the formula (3), thus regardless of a distance of the sub-pixel from the input voltage, the voltage or the current flowing through the sub-pixel will not be affected, so the brightness of the electroluminescence device (EL) will not be affected, thereby the IR-drop problem is avoided. The scheme of the embodiment of the present disclosure is capable of, through the pixel compensating circuit formed by eight transistors, one compensation storage capacitor C1 and four control signals, effectively addressing the problem of brightness non-uniformity of the display.

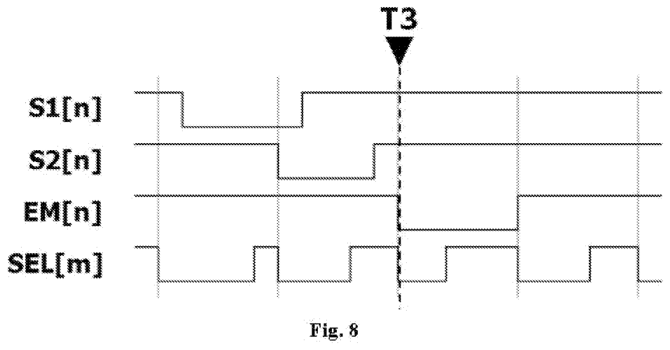

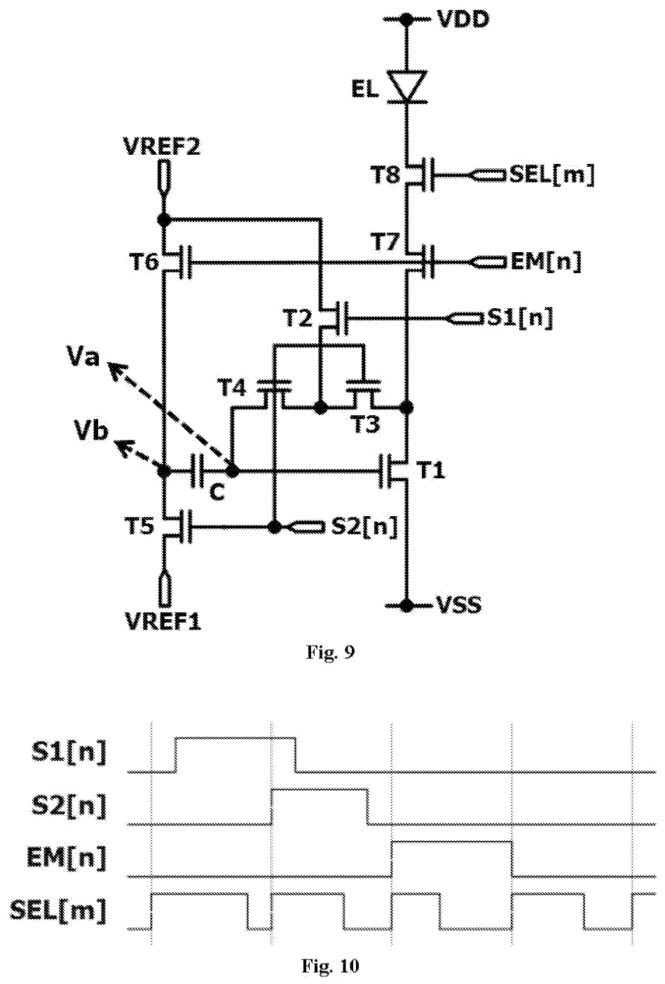

Further, in the second embodiment, as shown in FIG. 9 and FIG. 10, the fourth switch module 400 includes the eighth transistor T8, the control end of the eighth transistor T8 is connected with the fourth scanning line, the first end of the eighth transistor T8 is connected with the second end of the seventh transistor T7, and the second end of the eighth transistor T8 is connected with a negative pole of the electroluminescence device (EL). In the present embodiment, the eighth transistor T8 is an N-channel TFT transistor. For the N-channel transistor, the pixel compensating circuit is also formed by using eight transistors, one compensation storage capacitor C1 and four control signals. Although eight transistors are also adopted in the pixel compensating circuit using N-channel transistors, the placement position of the electroluminescence device (EL) is different. Although four control signals are also adopted in the pixel compensating circuit using N-channel transistors, the waveforms are reversed, the compensation functional operation remains the same, and the equivalent current formula after compensation is the same. Because a working process of the pixel compensating circuit using the P-channel transistors has been described in detail above, the working process of the pixel compensating circuit using the N-channel transistors is not repeatedly described.

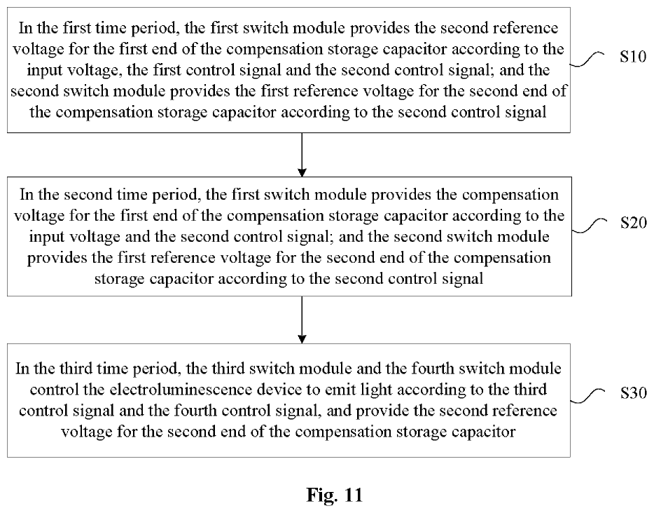

The embodiment of the present disclosure also provides a voltage compensating method based on the pixel compensating circuit accordingly. As shown in FIG. 11, the voltage compensating method based on the pixel compensating circuit includes the following operations.

At S10, in the first time period, the first switch module provides the second reference voltage for the first end of the compensation storage capacitor according to the input voltage, the first control signal and the second control signal; and the second switch module provides the first reference voltage for the second end of the compensation storage capacitor according to the second control signal;

At S20, in the second time period, the first switch module provides the compensation voltage for the first end of the compensation storage capacitor according to the input voltage and the second control signal; and the second switch module provides the first reference voltage for the second end of the compensation storage capacitor according to the second control signal; and

At S30, in the third time period, the third switch module and the fourth switch module control the electroluminescence device to emit light according to the third control signal and the fourth control signal, and provide the second reference voltage for the second end of the compensation storage capacitor.

The embodiment of the present disclosure also provides an electroluminescence display, the electroluminescence display includes a pixel array, the pixel array includes at least one pixel circuit, the pixel circuit includes three sub-pixel circuits, and each of the sub-pixel circuits includes an electroluminescence device and the pixel compensating circuit as mentioned above. Because the pixel compensating circuit has been described in detail above, the pixel compensating circuit is not repeatedly described here.

In conclusion, the scheme in the embodiments of the present disclosure provides an electroluminescence display, a pixel compensating circuit and a voltage compensating method based on the pixel compensating circuit. In the embodiments, the pixel compensating circuit includes a compensation storage capacitor, a first switch module, a second switch module, a third switch module and a fourth switch module. The first switch module is configured to provide a second reference voltage for a first end of the compensation storage capacitor in a first time period according to an input voltage, a first control signal and a second control signal, and provide a compensation voltage for the first end of the compensation storage capacitor in a second time period according to the input voltage and the second control signal. The second switch module is configured to provide a first reference voltage for a second end of the compensation storage capacitor in the first time period and the second time period according to the second control signal. The third switch module is configured to provide the second reference voltage for the second end of the compensation storage capacitor in a third time period according to a third control signal. The fourth switch module is configured to control an electroluminescence device to emit light in the third time period according to a fourth control signal. Through sequential control on each switch module, a function of compensating a voltage or a current is achieved, so that the brightness of the electroluminescence device (EL) does not vary with the change of the distance between the EL and the voltage input end, thereby a problem of brightness non-uniformity of the display is effectively addressed, and it can be guaranteed that each sub-pixel in the electroluminescence display has the same luminescence brightness.

It may be understood that equivalent replacements or changes may be made by those of ordinary skill in the art according to the technical schemes of the embodiments and inventive concepts of the present disclosure, and all of these changes or replacements shall fall within the scope of protection defined by the appended claims of the present disclosure.

What is claimed is:

1. A pixel compensating circuit, comprising a compensation storage capacitor, a first switch module, a second switch module, a third switch module and a fourth switch module, wherein the first switch module is configured to provide a second reference voltage for a first end of the compensation storage capacitor in a first time period according to an input voltage, a first control signal and a second control signal, and provide a compensation voltage for the first end of the compensation storage capacitor in a second time period according to the input voltage and the second control signal; the second switch module is configured to provide a first reference voltage for a second end of the compensation storage capacitor in the first time period and the second time period according to the second control signal; the third switch module is configured to provide the second reference voltage for the second end of the compensation storage capacitor in a third time period according to a third control signal; and the fourth switch module is configured to control an electroluminescence device to emit light in the third time period according to a fourth control signal.

2. The pixel compensating circuit as claimed in claim 1, wherein the first switch module comprises a first transistor, a second transistor, a third transistor and a fourth transistor; a first end of the first transistor is connected to electrical power, a control end of the first transistor and a first end of the fourth transistor are connected with the first end of the compensation storage capacitor, a first end of the third transistor and a second end of the first transistor are connected with the third switch module, a second end of the third transistor and a second end of the fourth transistor are connected with a first end of the second transistor, a second end of the second transistor is connected with an input end of the second reference voltage, a control end of the second transistor is connected with a first scanning line, and a control end of the third transistor and a control end of the fourth transistor are connected with a second scanning line.

3. The pixel compensating circuit as claimed in claim 2, wherein the second switch module comprises a fifth transistor, a control end of the fifth transistor is connected with the second scanning line, a first end of the fifth transistor is connected with an input end of the first reference voltage, and a second end of the fifth transistor is connected with the second end of the compensation storage capacitor.

4. The pixel compensating circuit as claimed in claim 2, wherein the third switch module comprises a sixth transistor and a seventh transistor, a control end of the sixth transistor and a control end of the seventh transistor are connected with a third scanning line, a first end of the sixth transistor is connected with the second end of the compensation storage capacitor, a second end of the sixth transistor is connected with the input end of the second reference voltage, a first end of the seventh transistor is connected with the second end of the first transistor, and a second end of the seventh transistor is connected with the fourth switch module.

5. The pixel compensating circuit as claimed in claim 4, wherein the fourth switch module comprises an eighth transistor, a control end of the eighth transistor is connected with a fourth scanning line, a first end of the eighth transistor is connected with the second end of the seventh transistor, and a second end of the eighth transistor is connected with a positive pole of the electroluminescence device.

6. The pixel compensating circuit as claimed in claim 4, wherein the fourth switch module comprises an eighth transistor, a control end of the eighth transistor is connected with a fourth scanning line, a first end of the eighth transistor is connected with the second end of the seventh transistor, and a second end of the eighth transistor is connected with a negative pole of the electroluminescence device.

7. The pixel compensating circuit as claimed in claim 2, wherein the first transistor, the second transistor, the third transistor and the fourth transistor are P-channel transistors; or the first transistor, the second transistor, the third transistor and the fourth transistor are N-channel transistors.

8. The pixel compensating circuit as claimed in claim 5, wherein the eighth transistor is a P-channel transistor.

9. A voltage compensating method based on the pixel compensating circuit as claimed in claim 1, wherein the voltage compensating method comprises the following operations:
in the first time period, providing, by the first switch module, the second reference voltage for the first end of the compensation storage capacitor according to the input voltage, the first control signal and the second control signal; and providing, by the second switch module, the first reference voltage for the second end of the compensation storage capacitor according to the second control signal;
in the second time period, providing, by the first switch module, the compensation voltage for the first end of the compensation storage capacitor according to the input voltage and the second control signal; and providing, by the second switch module, the first reference voltage for the second end of the compensation storage capacitor according to the second control signal; and
in the third time period, controlling the electroluminescence device to be luminous according to the third control signal and the fourth control signal and providing the second reference voltage for the second end of the compensation storage capacitor by the third switch module and the fourth switch module.

10. An electroluminescence display, comprising a pixel array, wherein the pixel array comprises at least one pixel circuit, the pixel circuit comprises three sub-pixel circuits, and each of the sub-pixel circuits comprises an electroluminescence device and a pixel compensating circuit, wherein the pixel compensating circuit comprises: a compensation storage capacitor, a first switch module, a second switch module, a third switch module and a fourth switch module,
the first switch module is configured to provide a second reference voltage for a first end of the compensation storage capacitor in a first time period according to an input voltage, a first control signal and a second control signal, and provide a compensation voltage for the first end of the compensation storage capacitor in a second time period according to the input voltage and the second control signal; the second switch module is configured to provide a first reference voltage for a second end of the compensation storage capacitor in the first time period and the second time period according to the second control signal; the third switch module is configured to provide the second reference voltage for the second end of the compensation storage capacitor in a third time period according to a third control signal; and the fourth switch module is configured to control an electroluminescence device to emit light in the third time period according to a fourth control signal.

11. The pixel compensating circuit as claimed in claim 6, wherein the eighth transistor is an N-channel transistor.

12. The voltage compensating method as claimed in claim 9, wherein in the third time period, controlling the electroluminescence device to be luminous according to the third control signal and the fourth control signal and providing the second reference voltage for the second end of the compensation storage capacitor by the third switch module and the fourth switch module comprises:
in the third time period, controlling, by the fourth switch module, the electroluminescence device to be luminous according to the third control signal and the fourth control signal, and providing, by the third switch module, the second reference voltage for the second end of the compensation storage capacitor.

13. The electroluminescence display as claimed in claim 10, wherein the first switch module comprises a first transistor, a second transistor, a third transistor and a fourth transistor; a first end of the first transistor is connected to electrical power, a control end of the first transistor and a first end of the fourth transistor are connected with the first end of the compensation storage capacitor, a first end of the third transistor and a second end of the first transistor are connected with the third switch module, a second end of the third transistor and a second end of the fourth transistor are connected with a first end of the second transistor, a second end of the second transistor is connected with an input end of the second reference voltage, a control end of the second transistor is connected with a first scanning line, and a control end of the third transistor and a control end of the fourth transistor are connected with a second scanning line.

14. The electroluminescence display as claimed in claim 13, wherein the second switch module comprises a fifth transistor, a control end of the fifth transistor is connected with the second scanning line, a first end of the fifth transistor is connected with an input end of the first reference voltage, and a second end of the fifth transistor is connected with the second end of the compensation storage capacitor.

15. The electroluminescence display as claimed in claim 13, wherein the third switch module comprises a sixth transistor and a seventh transistor, a control end of the sixth transistor and a control end of the seventh transistor are connected with a third scanning line, a first end of the sixth transistor is connected with the second end of the compensation storage capacitor, a second end of the sixth transistor is connected with the input end of the second reference voltage, a first end of the seventh transistor is connected with the second end of the first transistor, and a second end of the seventh transistor is connected with the fourth switch module.

16. The electroluminescence display as claimed in claim 15, wherein the fourth switch module comprises an eighth transistor, a control end of the eighth transistor is connected with a fourth scanning line, a first end of the eighth transistor is connected with the second end of the seventh transistor, and a second end of the eighth transistor is connected with a positive pole of the electroluminescence device.

17. The electroluminescence display as claimed in claim 15, wherein the fourth switch module comprises an eighth transistor, a control end of the eighth transistor is connected with a fourth scanning line, a first end of the eighth transistor is connected with the second end of the seventh transistor, and a second end of the eighth transistor is connected with a negative pole of the electroluminescence device.

18. The electroluminescence display as claimed in claim 15, wherein the first transistor, the second transistor, the third transistor and the fourth transistor are P-channel transistors; or the first transistor, the second transistor, the third transistor and the fourth transistor are N-channel transistors.

19. The electroluminescence display as claimed in claim 16, wherein the eighth transistor is a P-channel transistor.

20. The electroluminescence display as claimed in claim 17, wherein the eighth transistor is an N-channel transistor.
